(19) United States
(12) Patent Application Publication
(10) Pub. No.: US 2013/0081131 A1
(43) Pub. Date: Mar. 28, 2013

(54) COMMUNICATION SYSTEM, COMMUNICATION DEVICE, SERVER, AND COMMUNICATION METHOD

(71) Applicant: Takashi YOKOTA, Tokyo (JP)

(72) Inventor: Takashi YOKOTA, Tokyo (JP)

(73) Assignee: NEC CORPORATION, Tokyo (JP)

(21) Appl. No.: 13/617,393

(22) Filed: Sep. 14, 2012

(30) Foreign Application Priority Data
Sep. 26, 2011 (JP) 2011-208878

(51) Int. Cl. G06F 21/20

(52) U.S. Cl. 726/13

(57) ABSTRACT

A communication system includes a server that matches a packet against a definition pattern, provided for determining whether the packet is an invalid packet, and discards the packet if the packet is an invalid packet and, for other packets, notifies processing content, which is applied to the packets, to a sending source; and a communication device that forwards an unknown packet to the server and, based on processing content notified from the server, processes a received packet.

### TECHNICAL FIELD

### REFERENCE TO RELATED APPLICATION

The present application is based upon and claims the benefit of the priority of Japanese patent application No. 2011-208878 filed on Sep. 26, 2011, the disclosure of which is incorporated herein in its entirety by reference thereto.

The present invention relates to a communication system, a communication device, a server, a communication method, and a program, and more particularly to a communication system, which includes a communication device that inquires an external device about processing content to be applied to a received packet and learns the processing content, and to the communication device, a server, a communication method, and a program.

### BACKGROUND

Japanese Patent Kokai Publication No.2008-113409A discloses a traffic control system that takes action (filtering, bandwidth throttling, etc.) for abnormal traffic. According to the publication, the abnormal traffic detection device sends information on detected abnormal traffic to the management server when abnormal traffic is detected. Based on the abnormal-traffic sending source information included in the received abnormal traffic information, the management server identifies a user, who has sent abnormal traffic, via the authentication server. In addition, the management server sends a corrective action to the abnormal traffic detection device. This corrective action, a predefined abnormal-traffic corrective action prepared for each user, corresponds to the user who has sent abnormal traffic. The abnormal traffic detection device sets traffic control according to the corrective action.

WO Pamphlet WO2008/095010A, “OpenFlow: Enabling Innovation in Campus Networks” by Nick McKeown and seven other authors, [online], [Searched on Jul. 26, 2011], Internet <URL:http://www.openflow.org/documents/openflow-wp-latest.pdf>, and “Openflow Switch Specification” Version 1.1.0 Implemented (Wire Protocol 0x02) [Searched on Jul. 26, 2011], Internet <URL:http://www.openflow.org/documents/openflow-spec-v1.1.0.pdf> propose a mechanism called OpenFlow. In OpenFlow, each of the OpenFlow switches arranged in the network inquires the control device, called an OpenFlow controller, about processing content to be applied to a received packet and learns the processing content. OpenFlow offers advantages in that path control, error recovery, load balancing, and optimization can be implemented on a per-flow basis by low-cost switches.

### [Patent Document 1] Japanese Patent Kokai Publication No.JP-P2008-113409A

[Patent Document 2] WO Pamphlet No. W02008/095010A
[Non Patent Document 1] Nick McKeown and seven other authors, “OpenFlow: Enabling Innovation in Campus Networks” [online], [Searched on Jul. 26, 2011], Internet <URL:http://www.openflow.org/documents/openflow-wp-latest.pdf>
[Non Patent Document 2] “Openflow Switch Specification” Version 1.1.0 Implemented (Wire Protocol 0x02) [Searched on Jul. 26, 2011], Internet <URL:http://www.openflow.org/documents/openflow-spec-v1.1.0.pdf>

### SUMMARY

The disclosures of the above Patent Documents and Non Patent

Documents are incorporated herein by reference thereto.

The following analysis is given by the present disclosure. A communication device such as an OpenFlow switch, described in International Publication No. WO2008/095010A, “OpenFlow: Enabling Innovation in Campus Networks”, and “Openflow Switch Specification” given above, inquires an external device about processing content to be applied to a received packet and learns the processing content. Such a communication device has the problem that, when a large number of invalid packets are received, for example, when a DoS (Deny of Service Attack) is detected, the load of the device increases and, as a result, the processing for other valid packets is affected.

A method for use by a standard router for protecting against invalid packets is known. According to this method, the filtering processing is performed using a condition defined in advance by Media Access Control (MAC) addresses and Internet Protocol (IP) addresses. However, this method requires the communication device to perform the search operation by referencing the filter condition, expanded in the operation memory area of the communication device, each time a packet is received. Therefore, this method does not lead to a reduction in the load of the communication device of the type described above. In addition, a large amount of detailed, complex filter conditions, if registered for higher protection, uses a considerable amount of operation memory, thus increasing the load.

It is an object of the present disclosure to provide a communication system, a communication device, a server, a communication method, and a program that can contribute to prevent an increase in the load of a communication device of the type that inquires an external device about processing content to be applied to a received packet and learns the processing content while increasing resistance against an attack, such as a DoS attack, attempted on the communication device.

According to a first aspect, there is provided a communication system including a server that matches a packet against a definition pattern, provided for determining whether the packet is an invalid packet, and discards the packet if the packet is an invalid packet and, for other packets, notifies processing content, which is applied to the packets, to a sending source; and a communication device that forwards an unknown packet to the server and, based on processing content notified from the server, processes a received packet.

According to a second aspect, there is provided a communication device connected to a server that matches a packet against a definition pattern, provided for determining whether the packet is an invalid packet, and discards the packet if the packet is an invalid packet and, for other packets, notifies processing content, which is applied to the packets, to a sending source wherein the communication device forwards an unknown packet to the server and, based on processing content notified from the server, processes a received packet.

According to a third aspect, there is provided a server connected to the communication device described above wherein the server matches an unknown packet, received from the communication device, against a definition pattern, provided for determining whether the packet is an invalid packet, and discards the packet if the packet is an invalid packet and, for other packets, notifies processing content, which is applied to the packets, to the communication device.

According to a fourth aspect, there is provided a communication method including the steps of discarding a packet, whose processing content is inquired about by a communication device and which is determined as an invalid packet, using a definition pattern provided for determining whether the packet is an invalid packet; notifying processing content, which is applied to other packets, to the communication device; and processing a received packet based on the notified processing content. This method is associated with a particular machine called a server that notifies the communication device of the processing content.

According to a fifth aspect, there is provided a computer program that causes the communication device and the server described above to execute processing. This program may be recorded on a computer readable storage medium which is non-transitory. That is, the present disclosure may be implemented as a computer program product.

The meritorious effects of the present disclosure are summarized as follows.

The present disclosure allows a communication device of the type, which inquires an external device about processing content to be applied to a received packet and learns the processing content, to increase resistance against attacks such as Dos attacks and, at the same time, prevent an increase in the load of the communication device.

### BRIEF DESCRIPTION OF THE DRAWINGS

FIG. 1 is a diagram showing the configuration of one exemplary embodiment of the present disclosure.

FIG. 2 is a diagram showing the operation of one exemplary embodiment of the present disclosure.

FIG. 3 is a block diagram showing the configuration of a communication device (switch) in a first exemplary embodiment of the present disclosure.

FIG. 4 is a diagram showing the operation of the communication device (switch) in the first exemplary embodiment of the present disclosure.

FIG. 5 is a diagram showing the operation of the communication device (switch) in the first exemplary embodiment of the present disclosure.

FIG. 6 is a block diagram showing the configuration of a communication device (switch) in a second exemplary embodiment of the present disclosure.

FIG. 7 is a diagram showing the operation of the communication device (switch) in the second exemplary embodiment of the present disclosure.

FIG. 8 is a diagram showing the operation of the communication device (switch) in the second exemplary embodiment of the present disclosure.

FIG. 9 is a block diagram showing the configuration of a communication device (switch) in a third exemplary embodiment of the present disclosure.

### PREFERRED MODES

First, the outline of one exemplary embodiment of the present disclosure will be described below with reference to the drawings. It should be noted that the drawing reference numerals used in the description of the outline are attached to the elements as an example for convenience sake to help understand the present disclosure but are not intended to limit the present disclosure to the mode shown in the drawings.

One exemplary embodiment of the present disclosure may be implemented by the configuration that includes a server 20 and a communication device 10 that forwards an unknown packet to the server 20 and processes the received packet based on the processing content notified by the server 20. The unknown packet refers to a packet for which the communication device 10 does not have an entry, which defines the processing content for the packet, in the internal forwarding table or in the flow table described in “Openflow Switch Specification” given above.

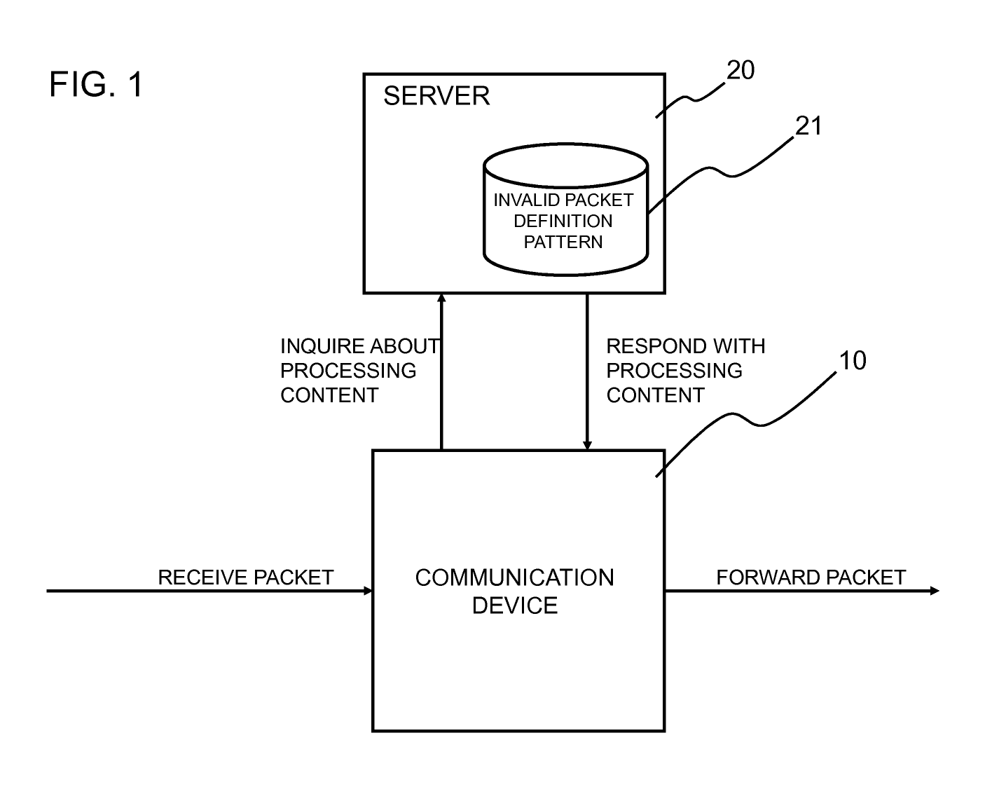

Upon receiving an unknown packet from the communication device 10, the server 20 matches the unknown packet against a definition pattern (invalid packet definition pattern 21 shown in FIG. 1) provided for determining if the received unknown packet is an invalid packet. If the packet is an invalid packet as the result of the matching, the server 20 discards the invalid packet. On the other hand, if the packet is not an invalid packet as the result of the matching, the server 20 notifies the processing content, which is applied to the packet (other packets), to the sending source communication device 10. The invalid packet definition pattern 21 may have a configuration that includes the MAC addresses and IP addresses for determining invalid sending sources or valid sending sources.

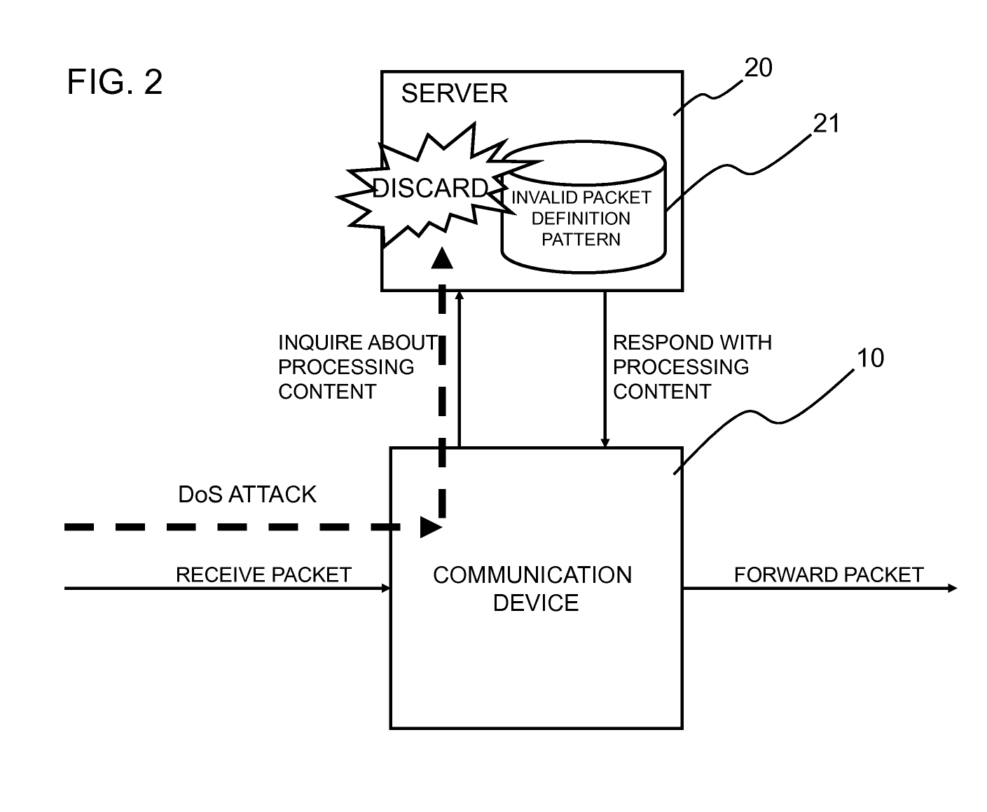

In the configuration described above, the communication device does not perform the matching processing based on the filter condition, as shown in FIG. 2, when invalid packets such as those of a DoS attack are sent to the communication device. Instead, the server matches invalid packets against the invalid packet definition pattern 21 and discards the packets as invalid packets. This configuration does not increase the load of the communication device even if the invalid packet definition pattern 21 in the server 20 is a detailed, complex pattern.

### First Exemplary Embodiment

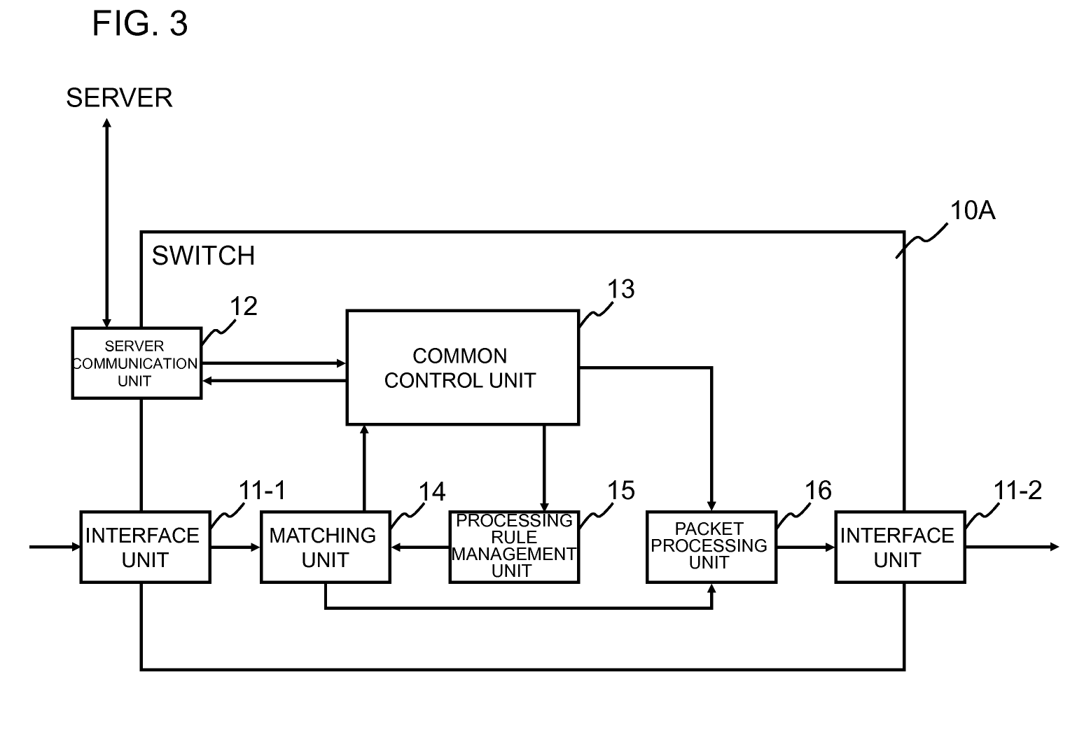

Next, the following describes a first exemplary embodiment of the present disclosure more in detail with reference to the drawings. FIG. 3 is a block diagram showing the configuration of a communication device (switch) in the first exemplary embodiment of the present disclosure.

FIG. 3 shows a switch 10A that includes interface units 11-1 and 11-2, a server communication unit 12, a common control unit 13, a matching unit 14, a processing rule management unit 15, and a packet processing unit 16.

Each of the interface units 11-1 and 11-2 is configured by a physical port that sends and receives a packet to and from other devices. Although two interface units are shown in the example in FIG. 3, three or more interface units may also be provided.

The server communication unit 12 is configured by an out-band port for communication with the server 20 shown in FIG. 1. The server communication unit 12 may also be configured by allocating the port of the interface unit for communication with the server.

The processing rule management unit 15 uses a table to manage the processing rules each composed of the correspondence between a matching key, which identifies a packet, and processing content (forwarding, header rewriting, and discarding) to be applied to a packet that matches the matching key. A flow entry described in “OpenFlow Switch Specifications” given above may be used as the processing rule. Those processing rules may also be stored in a table such as the flow table described in “OpenFlow Switch Specifications” given above.

The common control unit 13 sends an unknown packet to the server 20 in response to a request from the matching unit 14. In addition, when the matching key, which identifies the unknown packet, and the processing content to be applied to this matching key are received from the server 20, the common control unit 13 uses them to generate a processing rule and sends the generated processing rule to the processing rule management unit 15. The common control unit 13 also sends a packet (unknown packet), for which an instruction to send is received from the server 20, to the packet processing unit 16 to cause it to send the packet from the port (for example, interface unit 11-2) specified by the server 20. For the exchange of messages between the common control unit 13 and the server 20, the OpenFlow protocol messages—Packet-In message, Flow Mod message, and Packet-Out message—described in “OpenFlow Switch Specification” may be used.

The matching unit 14 matches the header of a packet, received from the interface unit 11-1, against the matching key of each of the processing rules stored in the processing rule management unit 15. If a processing rule having a matching key that matches the received packet is found as the result of the matching, the matching unit 14 sends the received packet as well as the processing content, defined by the processing rule, to the packet processing unit 16. On the other hand, if a processing rule having a matching key that matches the received packet is not found as the result of the comparison, the matching unit 14 sends the received packet to the common control unit 13 to request the common control unit 13 to set the processing rule corresponding to the received packet.

The packet processing unit 16 processes a received packet according to the processing content specified by the matching unit 14. For example, if the processing content specified by the matching unit 14 is forwarding from a particular port (for example, interface unit 11-2), the packet processing unit 16 sends the received packet from the interface unit 11-2. In addition, the packet processing unit 16 sends a packet from a specified port (for example, interface unit 11-2) according to an instruction from the server 20.

Each of the units (processing means) of the switch 10A shown in FIG. 3 may also be implemented by a computer program that causes a computer, which constitutes the switch 10A, to execute the processing described above using the hardware.

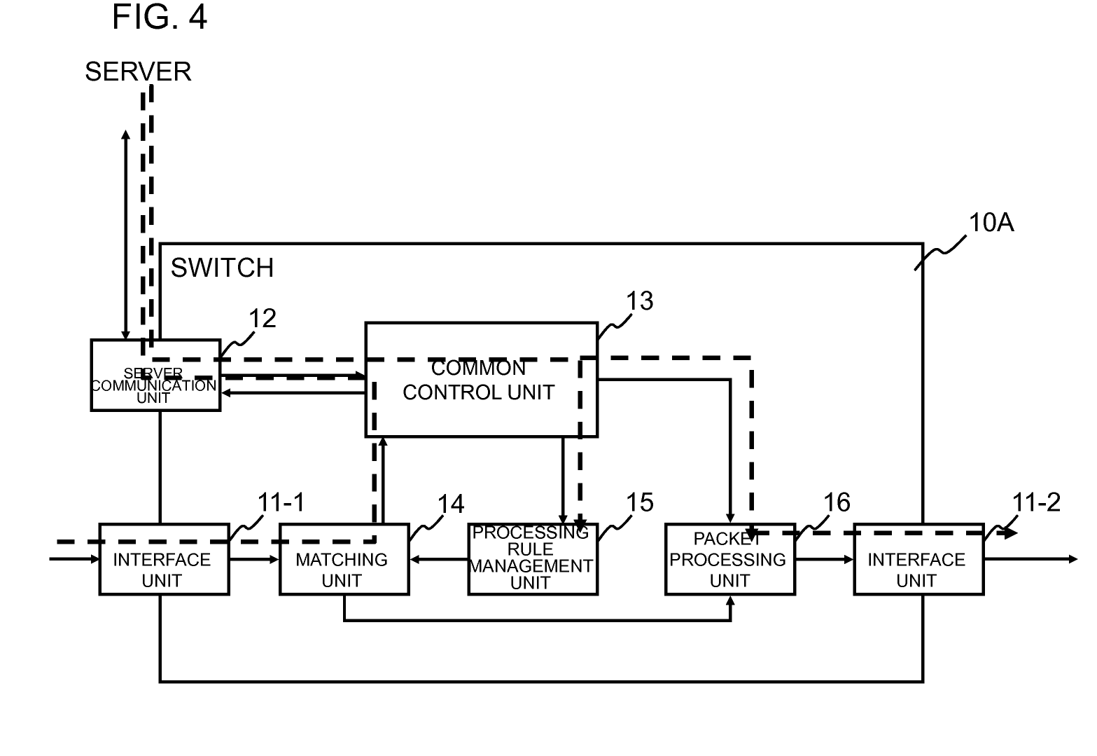

Next, the following describes the operation of this exemplary embodiment in detail with reference to the drawings. As shown in FIG. 4, when a packet is received from the interface unit 11-1, the matching unit 14 references the processing rule management unit 15 to search for a processing rule having a matching key corresponding to the received packet.

In this example, because the switch 10A receives a packet that is not yet learned, or a packet whose corresponding processing rule is not stored in the processing rule management unit 15, the matching unit 14 sends the received packet to the common control unit 13.

When the received packet is received, the common control unit sends the received packet to the server 20 via the server communication unit 12 to request the server 20 to generate and send the following two: one is a matching key for identifying the received packet and the other is processing content to be applied to a packet that will match the matching key.

When the packet is received from the switch 10A, the server 20 references the definition pattern (invalid packet definition pattern 21 shown in FIG. 1), prepared to determine whether the packet is an invalid packet, to determine whether the received packet is an invalid packet. If the received packet is an invalid packet as the result of the determination, the server 20 discards the received packet.

On the other hand, if the received packet is not an invalid packet as the result of the determination, the server 20 generates a matching key for identifying the received packet and processing content to be applied to a packet that will match the matching key and sends them to the switch 10A. In addition, the server 20 instructs the switch 10A to send the received packet from the specified port.

When the matching key for identifying the received packet and the processing content to be applied to a packet that will match this matching key are received, the common control unit 13 uses the matching key and the processing content to generate a processing rule and sends the generated processing rule to the processing rule management unit 15. After this processing rule is stored in the processing rule management unit 15, the subsequent packets, which will match the matching key, will be processed according to the processing rule.

When the instruction to send the received packet is received, the common control unit 13 sends the received packet and the instruction content, included in the instruction received from the server 20, to the packet processing unit 16.

The packet processing unit 16 processes the received packet according to the instruction content. For example, if the instruction content received from the server 20 specifies that the received packet be sent from a particular port (for example, interface unit 11-2), the packet processing unit 16 sends the received packet from the particular port (for example, interface unit 11-2).

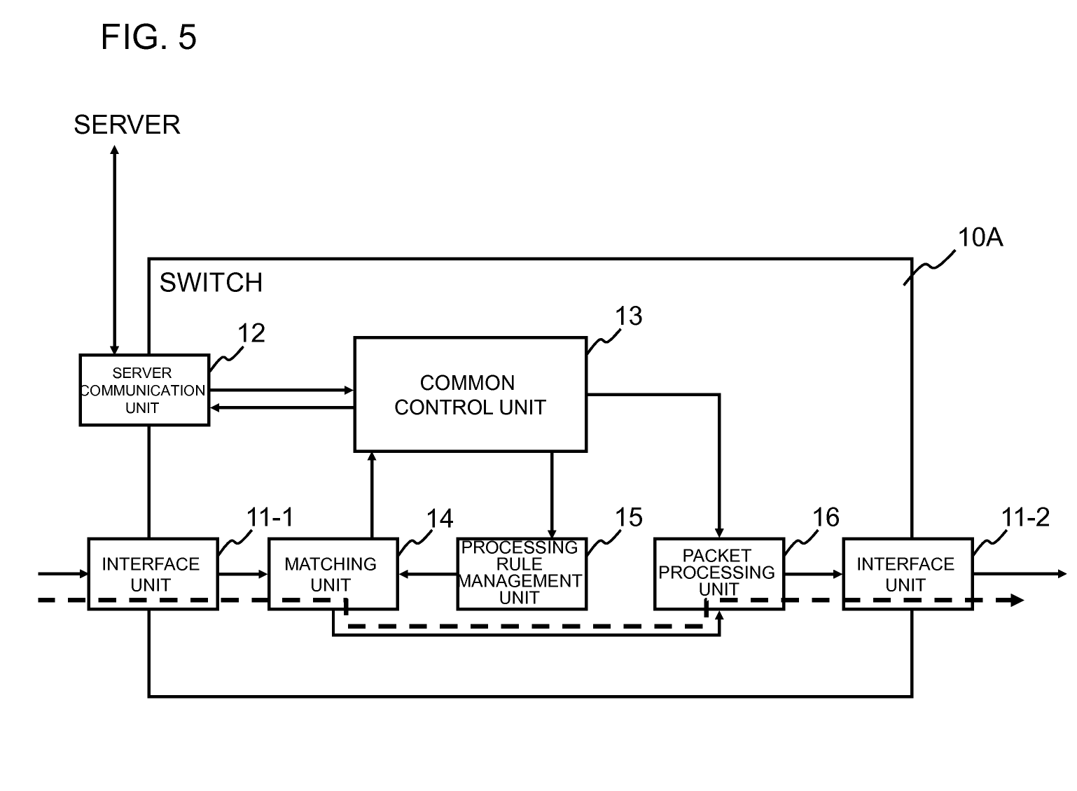

After that, when a subsequent packet is received from the interface unit 11-1 as shown in FIG. 5, the matching unit 14 references the processing rule management unit 15 to search for a processing rule that has the matching key corresponding to the received packet.

In this example, because the switch 10A receives a packet that has been learned, or the packet for which the corresponding processing rule is stored in the processing rule management unit 15, the matching unit 14 extracts the processing rule that has the matching key corresponding to the received packet. The matching unit 14 sends the received packet and the processing content, defined for the extracted processing rule, to the packet processing unit 16.

The packet processing unit 16 processes the received packet according to the processing content. For example, if the processing content received from the matching unit 14 specifies that the received packet be sent from a particular port (for example, interface unit 11-2), the packet processing unit 16 sends the received packet from the specified port (for example, interface unit 11-2).

In this exemplary embodiment, the switch 10A requests the server 20 to perform the invalid-packet filtering processing as described above to reduce the load of the switch 10A. In addition, the user can update the invalid-packet definition pattern, stored in the server 20, as necessary to enhance protection.

### Second Exemplary Embodiment

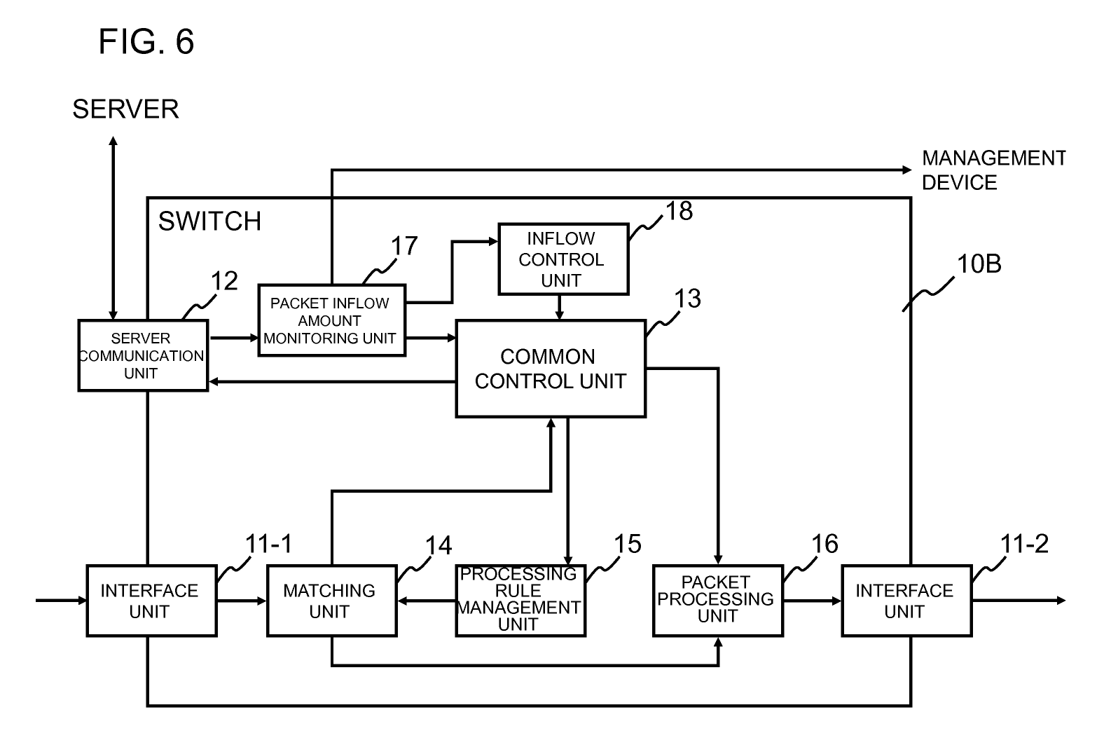

Next, the following describes a second exemplary embodiment of the present disclosure, in which a new function is added to the switch in the first exemplary embodiment, in detail with reference to the drawings. FIG. 6 is a block diagram showing the configuration of a communication device (switch) in the second exemplary embodiment of the present disclosure.

The difference between the switch 10A in the first exemplary embodiment shown in FIG. 3 and a switch 10B in the second exemplary embodiment shown in FIG. 6 is that a packet inflow amount monitoring unit (inflow monitoring unit) 17 and an inflow control unit 18 are added between the server communication unit 12 and the common control unit 13 of the switch 10B. Because the other part of the configuration is almost similar to that of the first exemplary embodiment described above, the following describes the second exemplary embodiment with emphasis on the difference.

For the packets that are determined by the server 20 as non-invalid, the packet inflow amount monitoring unit 17 calculates the inflow amount per unit time. If the inflow amount per unit time exceeds a predetermined threshold, the packet inflow amount monitoring unit 17 forwards the processing rule and the packet sending instruction, received from the server 20, not to the common control unit 13, but to the inflow control unit 18. In addition, if the inflow amount per unit time exceeds the predetermined threshold, the packet inflow amount monitoring unit 17 sends a notification to a predetermined monitoring device.

The inflow control unit 18 discards the processing rule and the packet sending instruction received from the server 20. Preferably, the inflow control unit 18 may request the common control unit 13 to set a processing rule, according to which packets are discarded if the inflow amount per unit time exceeds the predetermined threshold, in the processing rule management unit 15.

Next, the following describes the operation of this exemplary embodiment in detail with reference to the drawings. When a processing rule and a sending instruction for a packet, which is determined by the server 20 as a non-invalid packet, are received, the packet inflow amount monitoring unit 17 updates the inflow amount per unit time.

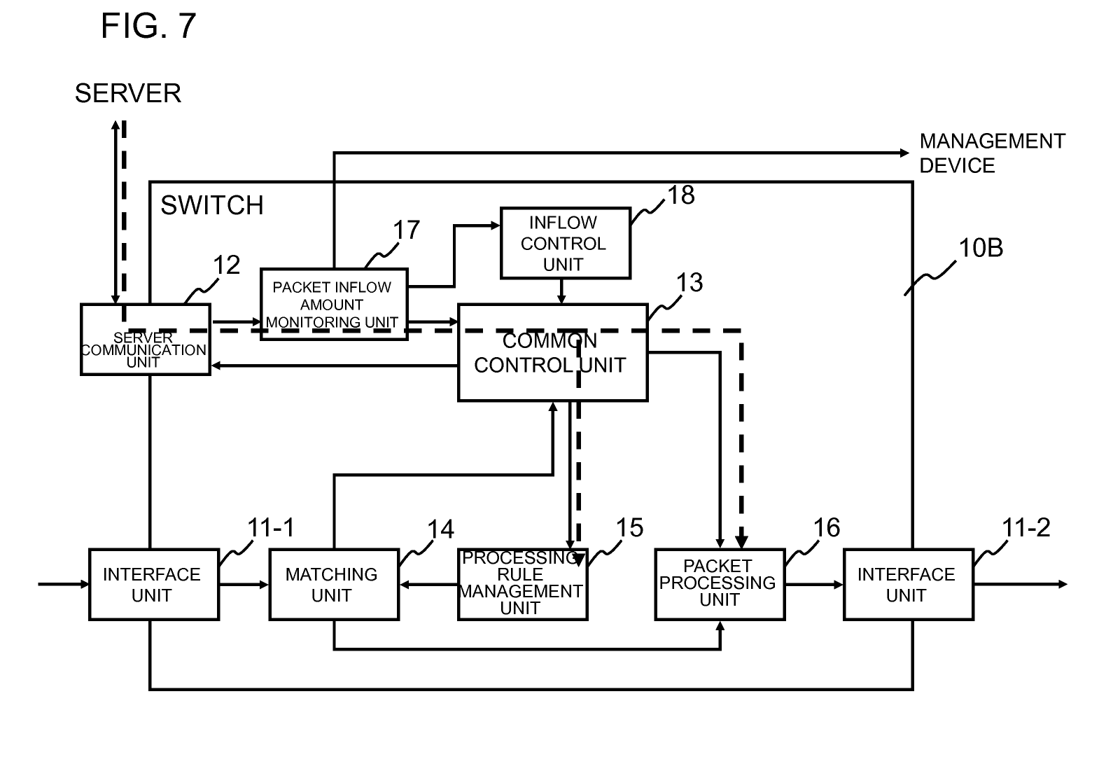

If the inflow amount per unit time is equal to or smaller than the predetermined threshold, the packet inflow amount monitoring unit 17 forwards the processing rule and the sending instruction for the packet to the common control unit 13 as in the first exemplary embodiment (see FIG. 7).

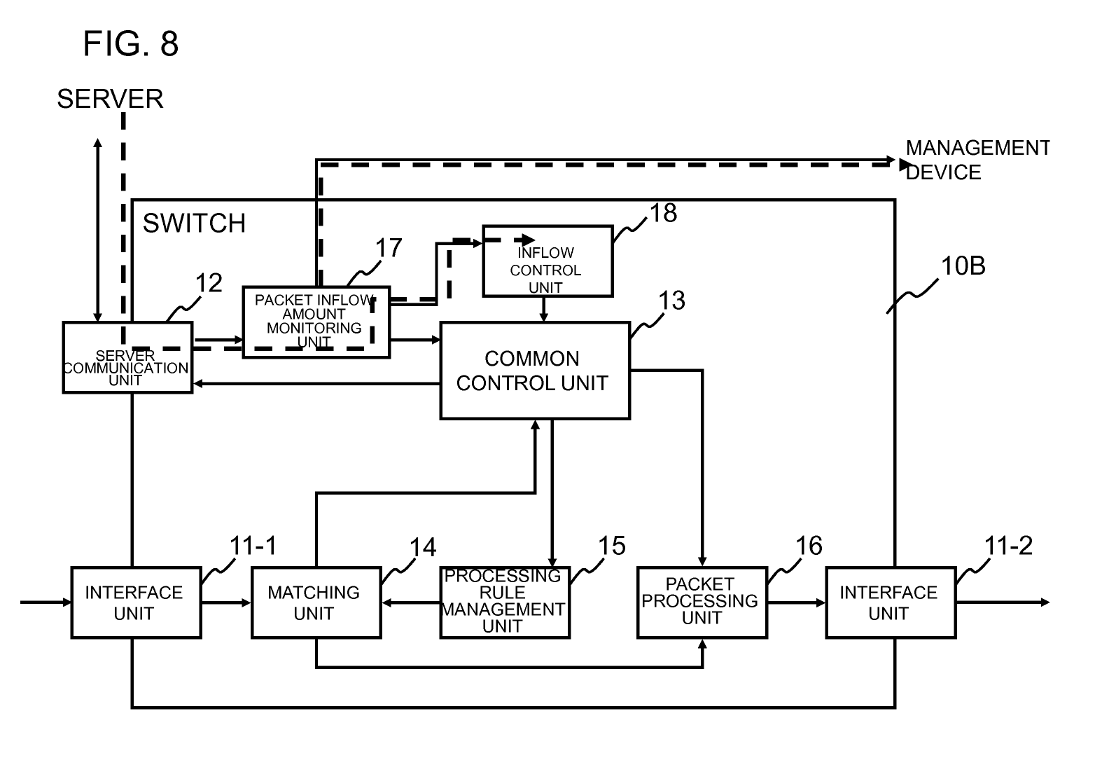

On the other hand, if the inflow amount per unit time exceeds the predetermined threshold, the packet inflow amount monitoring unit 17 forwards the processing rule and the sending instruction for the packet to the inflow control unit 18 and, in addition, sends them to the management device as shown in FIG. 8 (see FIG. 8).

As described above, if a packet is determined by the server 20 as a non-invalid packet but the inflow amount per unit time is larger than the predetermined threshold, this exemplary embodiment prevents the packet from being forwarded. The reason is that the packet inflow amount monitoring unit 17 is configured to monitor the inflow amount of packets determined as non-invalid packets and, if the value of the inflow amount is abnormal, to prevent packets from being forwarded.

### Third Exemplary Embodiment

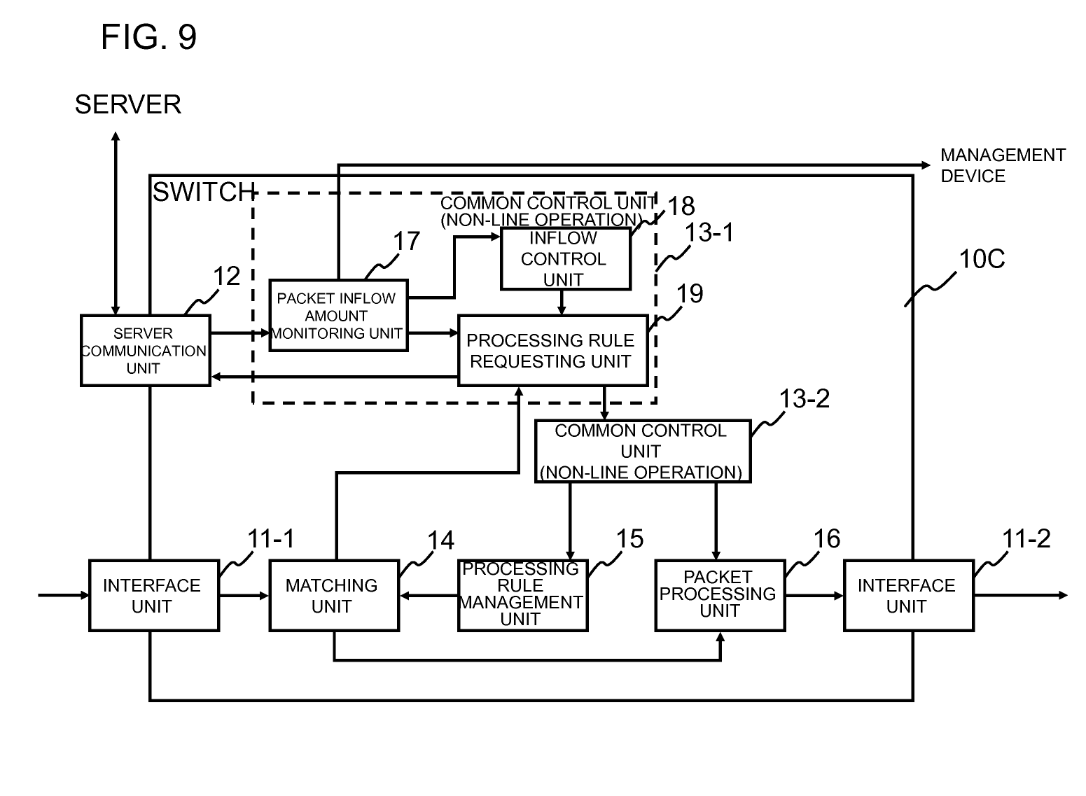

Next, the following describes a third exemplary embodiment of the present disclosure in detail, in which redundancy is added to the common control unit of a switch, with reference to the drawings. FIG. 9 is a block diagram showing the configuration of a communication device (switch) in the third exemplary embodiment of the present disclosure.

A switch 10C in the third exemplary embodiment shown in FIG. 9 differs from the switch 10B in the second exemplary embodiment shown in FIG. 6 in that the common control unit 13 is divided into two, common control unit (non-production; first control unit) 13-1 and common control unit (production; second control unit) 13-2, in such a way that these two control units can operate independently of each other. Because the other part of the configuration is almost similar to that of the second exemplary embodiment described above, the following describes the third exemplary embodiment with emphasis on the difference.

The common control unit (non-line operation) 13-1 includes a processing rule requesting unit 19, which forwards an unknown packet to the server 20 side, the packet inflow amount monitoring unit 17, and the inflow control unit 18 described above.

The common control unit (production) 13-2 sends a processing rule to the processing rule management unit 15, and a packet sending instruction to the packet processing unit 16, based on a response from the server 20.

The basic operation of the switch 10C in this exemplary embodiment is similar to that of the switch 10B the second exemplary embodiment described above. In this exemplary embodiment, the common control unit (non-line operation) 13-1 is responsible for processing an unexpected, unknown packet and for monitoring the packet inflow amount as described above. This configuration therefore prevents the common control unit (line operation) 13-2 from being affected by a large number of invalid packets even if they are received.

While the exemplary embodiments of the present disclosure have been described, it is to be understood that the present disclosure is not limited to the exemplary embodiments above and that further modifications, replacements, and adjustments may be added within the scope not departing from the basic technological concept of the present disclosure. For example, the configurations of the switches and servers in the exemplary embodiment are shown to describe the present disclosure simply and may be changed as necessary. Although the exemplary embodiments are based on OpenFlow that is a related art, the present disclosure is not limited to those based on OpenFlow. For example, not only OpenFlow but also a communication architecture, in which a control device integrally controls the forwarding routes of packets, may be applied to the present disclosure.

For example, though the switch requests the server to determine whether a received packet is an invalid packet and to determine processing content in the exemplary embodiments described above, a similar mechanism may also be provided in the device on the user side. Such a configuration prevents an invalid packet from flowing in the network and allows the flow control (packet forwarding, packet discarding, header rewriting) to be performed on the side closer to the user.

Finally, the following summarizes preferred modes of the present disclosure, however, not limitative.

### [First Mode]

(See the communication system in the first aspect above)

### [Second Mode]

In the first mode,

if the packet is an invalid packet as a result of the matching against the definition pattern, the server discards the invalid packet and, at the same time, notifies processing content, which requests that a packet that has the same characteristics as the invalid packet be discarded, to the communication device.

### [Third Mode]

In the first or second mode,

the communication device includes an inflow monitoring unit that monitors a packet inflow amount received from the same sending source within a predetermined time; and an inflow control unit that performs a predetermined action when a packet is received from a sending source, whose packet inflow amount has exceeded a predetermined threshold, even if the packet is determined by the predetermined server as a non-invalid packet.

### [Fourth Mode]

In the third mode,

the predetermined action performed by the inflow control unit is to stop forwarding the packet.

### [Fifth Mode]

In the third mode,

the inflow control unit notifies a predetermined management device that the packet inflow amount has exceeded the predetermined threshold.

### [Sixth Mode]

In one of the third to fifth modes,

in the communication device, a first control unit and a second control unit are configured to operate independently of each other, the first control unit including at least the inflow monitoring unit and the inflow control unit, the second control unit operating according to processing content notified by the server.

### [Seventh Mode]

(See the communication device in the second aspect above)

### [Eighth Mode]

In the seventh mode,

the communication device further includes an inflow monitoring unit that monitors a packet inflow amount received from the same sending source within a predetermined time; and an inflow control unit that performs a predetermined action when a packet is received from a sending source, whose packet inflow amount has exceeded a predetermined threshold, even if the packet is determined by the predetermined server as a non-invalid packet.

### [Ninth Mode]

(See the server in the third aspect above)

### [Tenth Mode]

(See the communication method in the fourth aspect above)

### [Eleventh Mode]

(See the program in the fifth aspect above)

Specific modes may be derived from the seventh mode and the ninth to eleventh modes in the same manner as the second to sixth modes are derived from the first mode.

What is claimed is:

1. A communication system, comprising:
a server that matches a packet against a definition pattern, provided for determining whether the packet is an invalid packet, and discards the packet if the packet is an invalid packet and, for other packets, notifies processing content, which is applied to the packets, to a sending source; and
a communication device that forwards an unknown packet to said server and, based on processing content notified from said server, processes a received packet.

2. The communication system as defined by claim 1, wherein
if the packet is an invalid packet as a result of the matching against the definition pattern, said server discards the invalid packet and, at the same time, notifies processing content, which requests that a packet that has the same characteristics as the invalid packet be discarded, to said communication device.

3. The communication system as defined by claim 1, wherein
said communication device comprises an inflow monitoring unit that monitors a packet inflow amount received from the same sending source within a predetermined time; and an inflow control unit that performs a predetermined action when a packet is received from a sending source, whose packet inflow amount has exceeded a predetermined threshold, even if the packet is determined by said predetermined server as a non-invalid packet.

4. The communication system as defined by claim 3, wherein the predetermined action performed by said inflow control unit is to stop forwarding the packet.

5. The communication system as defined by claim 3, wherein said inflow control unit notifies a predetermined management device that the packet inflow amount has exceeded the predetermined threshold.

6. The communication system as defined by claim 3, wherein
in said communication device, a first control unit and a second control unit are configured to operate independently of each other, the first control unit including at least said inflow monitoring unit and said inflow control unit, the second control unit operating according to processing content notified by said server.

7. A server connected to a communication device that forwards an unknown packet to said server and, based on processing content notified from said server, processes a received packet, wherein
said server matches the unknown packet, received from said communication device, against a definition pattern, provided for determining whether the packet is an invalid packet, and discards the packet if the packet is an invalid packet and, for other packets, notifies processing content, which is applied to the packets, to said communication device.

8. A communication method, comprising:
discarding a packet, whose processing content is inquired about by a communication device and which is determined as an invalid packet, using a definition pattern provided for determining whether the packet is an invalid packet;
notifying processing content, which is applied to other packets, to said communication device; and
processing a received packet based on the notified processing content.

9. The communication system as defined by claim 2, wherein
said communication device comprises an inflow monitoring unit that monitors a packet inflow amount received from the same sending source within a predetermined time; and an inflow control unit that performs a predetermined action when a packet is received from a sending source, whose packet inflow amount has exceeded a predetermined threshold, even if the packet is determined by said predetermined server as a non-invalid packet.

10. The communication system as defined by claim 4, wherein
in said communication device, a first control unit and a second control unit are configured to operate independently of each other, the first control unit including at least said inflow monitoring unit and said inflow control unit, the second control unit operating according to processing content notified by said server.

11. The communication system as defined by claim 5, wherein
in said communication device, a first control unit and a second control unit are configured to operate independently of each other, the first control unit including at least said inflow monitoring unit and said inflow control unit, the second control unit operating according to processing content notified by said server.
